(19) United States
(12) Patent Application Publication
(10) Pub. No.: US 2009/0020074 A1
(43) Pub. Date: Jan. 22, 2009

(54) Remote Control Wildlife Feeder

(76) Inventor: KARL HARMAN, New Ulm, TX (US)

Correspondence Address: WOOD AND EISENBERG, PLLC, 6911 RICHMOND HIGHWAY, SUITE 403, Alexandria, VA, 22306, US

(21) Appl. No.: 12/177,129

(22) Filed: Jul. 21, 2008

Related U.S. Application Data
(60) Provisional application No. 60/951,196, filed on Jul. 21, 2007.

(51) Int. Cl. A01K 5/02

(52) U.S. Cl. 119/51.11

(57) ABSTRACT

A remote control wildlife feeder has an antenna and a receiver which receives a signal transmitted by a transmitter. The receiver includes a microprocessor, a relay having a positive electrical output, and a relay having a negative electrical output. A power supply provides power to operate the microprocessor and the relays. The antenna is connected by a line to the microprocessor. An internal timer is included in the microprocessor which is usable in the receiver. The RF signal arrives along a line from the antenna to the internal timer and, if the timer permits, to a filter. The feeder also includes a power supply, a motor, and a feeder mechanism.

### CONTINUING STATUS AND CROSS REFERENCE TO RELATED APPLICATIONS

This application claims the priority of Provisional Patent Application Ser. No. 60/951,196 filed on Jul. 21, 2007, the entire disclosure of which is hereby expressly incorporated herein by reference thereto.

### STATEMENT REGARDING FEDERALLY SPONSORED RESEARCH OR DEVELOPMENT

Not applicable.

### FIELD OF THE INVENTION

The present invention relates generally to an apparatus for feeder controllers, and more specifically to a receiver and feeder motor controller. More particularly, this invention is directed to an apparatus or device for remote control of wildlife feeding stations, with efficient use of energy by the receiver.

### BACKGROUND OF THE INVENTION

Wildlife feeders are known in the animal husbandry arts. Such feeders can be as simple as a gravity fed column of feed, or a motor-operated feeding station set to operate at a timed schedule.

However, the prior art wildlife feeders that operate on a timed schedule are inefficient in that sometimes more feed should be distributed, such as when many animals or birds are in the vicinity and required additional food. Furthermore, they inefficiently distribute food that is sometimes unneeded by the wildlife. For example, where deer are the targeted wildlife, and no deer are present for a long while, automated timed release of the feed would be wasteful, both in terms on the foodstock and in terms of the energy consumption of the motor operating the feeder. Where a battery is used to supply power to the automated feeder, wasted feed is also accompanied by a waste of the charge on the battery, and the battery will run out of power sooner.

There is a need for an apparatus or device for remote control of wildlife feeding stations, with efficient use of energy by the receiver.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an apparatus or device for remote control of wildlife feeding stations, with efficient use of energy by the receiver.

The device according to the present invention includes a remote control wildlife feeder which has an antenna and a receiver which receives a signal transmitted by a transmitter. The receiver includes a microprocessor, a relay having a positive electrical output, and a relay having a negative electrical output. A power supply provides power to operate the microprocessor and the relays. The antenna is connected by a line to the microprocessor. An internal timer is included in the microprocessor which is usable in the receiver. The RF signal arrives along a line from the antenna to the internal timer and, if the timer permits, to a filter. The filter operates to filter the received signal and determines whether a signal has been received or not, and if so, activates an output to actuate the relays. The feeder having a receiver also includes a power supply, a motor, and a feeder mechanism. For a deer feeder, for example, the feeder mechanism is actuated by the relays to dispense feed for a period of, for example, 5 seconds.

Other objects and advantages of the present invention will be more readily apparent from the following detailed description when read in conjunction with the accompanying drawings.

### BRIEF DESCRIPTION OF THE DRAWINGS

FIG. 1 is schematic block diagram of elements of a remote control wildlife feeder having a receiver, according to the present invention.

FIG. 2 is a schematic block diagram of an internal timer of a microprocessor usable in the receiver of FIG. 1, according to the present invention.

FIG. 3 is a schematic block diagram of the receiver of FIG. 1 used together with a power supply, motor, and feeder mechanism.

FIG. 4 is a flowchart depicting steps usable in the microprocessor of FIG. 2 for controlling the receiver of FIG. 1.

### DETAILED DESCRIPTION OF THE INVENTION

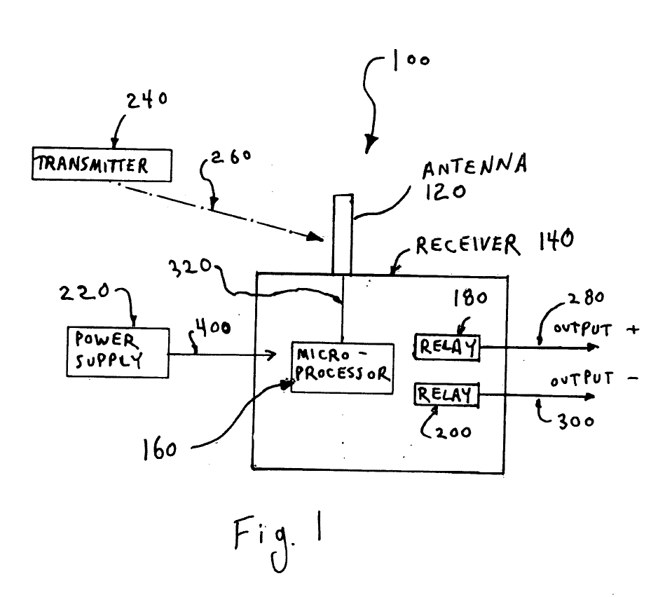

FIG. 1 is schematic block diagram of elements of a remote control wildlife feeder 100 having an antenna 120 and a receiver 140 which receives a signal 260 transmitted by a transmitter 240. The receiver 140 includes a microprocessor 160, a relay 180 having a positive electrical output 280, and a relay 200 having a negative electrical output 300.

In FIG. 1, a power supply 220 provides power as indicated by arrow 400, to operate the microprocessor 160 and the relays 180 and 200. The antenna 120 is connected by a line 320 to the microprocessor 160.

Any suitable microcontroller 160 can be used, but a low power microcontroller 160 is preferred such as, but not limited to, the MSP430 Ultra-Low Power Microcontroller supplied by Texas Instruments; the microcontroller is designated as “MSP430F20x1”. By using an ultra-low power microcontroller 160 the receiver 140 can operate on less than 1 mA.

FIG. 2 is a schematic block diagram of an internal timer 340 of the microprocessor 160 usable in the receiver 140 of FIG. 1. The RF signal arrives along line 320 from the antenna 120 (shown in FIG. 1) to the internal timer 340 and, if the timer 340 permits, to a filter 360. The filter 360 filters the received signal and determines whether a signal 260 has been received or not, and if so, activates an output 380 to actuate the relays 280, 300.

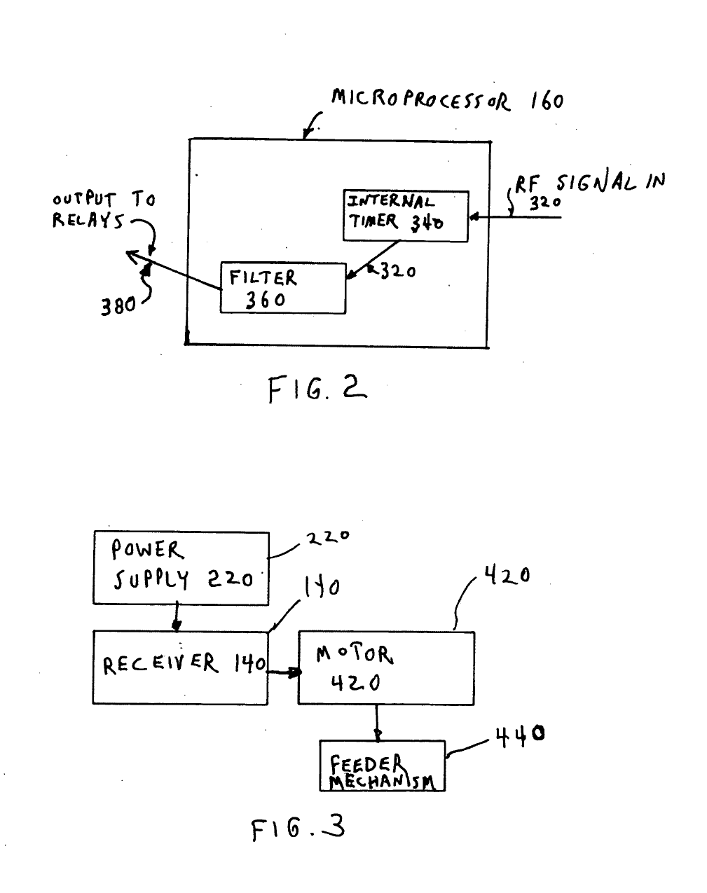

FIG. 3 is a schematic block diagram of the receiver 140 of FIG. 1 used together with a power supply 220, a motor 420, and a feeder mechanism 440. For a deer feeder, for example, the feeder mechanism is actuated by the relays 280, 300 to dispense feed for a period of, for example, 5 seconds. Other time periods can also be used, and such variations are contemplated as being within the scope of the present invention. A typical deer feeder can dispense feed radially. Other types of wildlife feeders are contemplated as being within the scope of the present invention.

Typical automatic wildlife feeders have small power supplies and therefore when a typical remote control is installed that searches for a signal 24 hours a day, the power supply depletes very quickly.

The remote control wildlife feeder 100 activates 6 volt or 12 volt motor(s) 420 on remote controlled wildlife feeders. This gives the operator the opportunity to activate the automatic feeder 100 from a viewing distance without waiting for timer activation. The remote control wildlife feeder 100 can also have an automatic feeding mode, not shown, in which the remote control wildlife feeder 100 operates on a predetermined feeding schedule in the absence of a remote control signal.

A significant and important feature of the remote control wildlife feeder 100 is that it has less than ⅓ of a milli-amp power consumption and therefore has a very minute power drain on the wildlife feeder battery 220.

The microprocessor 160 looks for a signal approximately every three-quarter of a second. As it activates looking for a signal, it filters out incorrect signals. This is done in microseconds. If it recognizes a correct RF signal, then it activates relays 180, 200 for both legs of outputs 280, 300 respectively.

Both legs of the output of the remote control wildlife feeder 100 are activated because typical wildlife feeder timers activate either the + or − side of a motor and are either normally + or normally − on the other leg. The remote control wildlife feeder 100 can be installed in line with any known type of timer or motor. And, as shown in the drawings, it does not have to be connected in conjunction with a timer. It can be directly wired to a motor or any other driven devices such as relays or lighting.

In operation, a signal is received from the hand held transmitter 240 which is activated at the holder's discretion. Every ¾ of a second the receiver wakes up by the internal timer operation and looks for a signal 260 received through the antenna 120. It may stay awake from just a few micro seconds to 50-60 microseconds depending on how much filtering is done. It processes (filters) incorrect signals using the microprocessor 160. If it recognizes a correct signal, the microprocessor 160 then activates the relays 180, 200 which in turn activate a driven external circuit. In the present instance, the typical driven circuit is a wildlife feeder motor 420. It is driven for a predetermined time of 5 seconds also from the microprocessor 160. This predetermined time of 5 seconds can be changed in the programming.

When operating a wildlife feeder it is helpful to have both a very efficient means of operating the wildlife feeder 100, and a flexible means of operating the wildlife feeder 100. In the present invention this is achieved using a receiver that requires less than ⅓ of a milli-amp on standby mode and is adapted to operatively respond to inputs from a wireless remote 240 such as, but not limited to, an RF transmitter or an infra-red remote, though an RF transmitter is preferred. In response to signals received from a transmitter, the receiver 140 of the present invention sends control signals to operate a feeder motor 420.

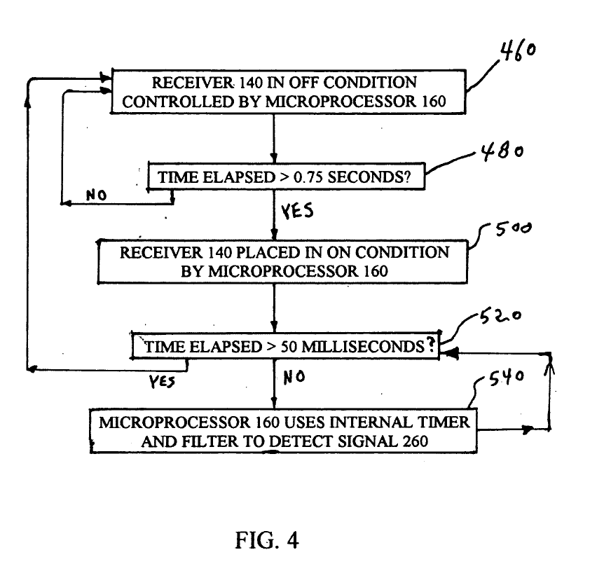

FIG. 4 is a flowchart depicting steps usable in the microprocessor 160 of FIG. 2 for controlling the receiver 140 of FIG. 1. At step 460, the receiver 140 is placed or maintained in an OFF condition, controlled by the microprocessor 160.

At step 480, a test is made within the microprocessor 160 whether a specified time period has elapsed; in the exemplary embodiment, this time period is 0.75 seconds (three quarters of a second). If “yes”, then operation proceeds to step 500; if “no” then operation returns to step 460 maintaining the receiver 140 in the OFF state.

At step 500, the receiver 140 is placed in an ON condition by the microprocessor 160.

At step 520, a test is made whether the time elapsed (in the ON state) exceeds 50 milliseconds. If “yes”, control proceeds to step 460 and the receiver 140 is placed in the OFF state. If “no”, control passes to or continues with, step 540 in which the receiver 140 detects whether the signal 260 is received or not.

At step 540, the microprocessor 160 uses an internal timer and filter to detect the signal 260. Control passes back to step 520 regardless of whether the signal 260 has been detected or not, so that the receiver 140 is on for a total of no more than 50 milliseconds as controlled by step 520.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A remote control wildlife feeder, comprising:
a transmitter for producing an output signal in response to a manual actuation;
a receiver for receiving the signal produced by said transmitter; said receiver having power relays, an antenna, and a microprocessor;
a power supply for powering the receiver; and
a feeding mechanism powered by the receiver for a predetermined period of time;
wherein the receiver is controlled by said microprocessor to be in an ON mode for a relatively very small amount of time in comparison to the time spent in a standby mode;
whereby the receiver consumes relatively little power.

2. A remote control wildlife feeder as claimed in claim 1, wherein receiver is in an ON state for 50 milliseconds or less, and in a standby mode for approximately three quarters of a second, the ON state and standby mode repeating indefinitely.

3. A remote control wildlife feeder as claimed in claim 1, wherein microprocessor includes an ultra-low power microcontroller.

4. A remote control wildlife feeder as claimed in claim 3, wherein the ultra-low power microcontroller is an MSP430 Ultra-Low Power Microcontroller supplied by Texas Instruments, designated as “MSP430F20x1”.

5. A remote control wildlife feeder as claimed in claim 1, wherein the feeding mechanism is a deer feeder.

6. A remote control wildlife feeder as claimed in claim 1, wherein the feeding mechanism is a bird feeder.

7. A remote control wildlife feeder as claimed in claim 1, wherein the transmitter is an IR transmitter.

8. A remote control wildlife feeder as claimed in claim 1, wherein the transmitter is an RF transmitter.
